(19) United States
(12) Patent Application Publication
(10) Pub. No.: US 2005/0223576 A1
(43) Pub. Date: Oct. 13, 2005

(54) Single calibration dual vial for leveling apparatuses and applications

(76) Inventor: Dane Scarborough, Hailey, ID (US)

Correspondence Address: STEPHEN M. NIPPER;DYKAS, SHAVER & NIPPER, LLP, PO BOX 877, BOISE, ID, 83701-0877, US

(21) Appl. No.: 11/102,478

(22) Filed: Apr. 8, 2005

Related U.S. Application Data
(60) Provisional application No. 60/562,139, filed on Apr. 13, 2004.

(51) Int. Cl. G01C 9/24

(52) U.S. Cl. 33/379

(57) ABSTRACT

A generally L-shaped spirit level vial having a vertical portion that is perpendicular to a horizontal portion. Both the vertical and horizontal portions fluidly interconnected so that the same, combined vial can be used either horizontally or vertically. Thus, only one of said vials need to be calibrated.

### PRIORITY

This application is a non-provisional application which claims the priority date from the provisional application entitled SPIRIT LEVEL DUAL VIAL filed by Dane Scarborough on Apr. 13, 2004 with application Ser. No. 60/562,139, the disclosure of which is incorporated herein by reference.

### BACKGROUND OF THE INVENTION

Field of the Invention. The present invention generally relates to spirit or other liquid filled leveling devices, and more particularly relates to such leveling devices configured for use in both horizontal and vertical applications.

Background Information. Spirit filled levels was invented in France during the 17^{th} Century. Spirit levels (also known as “bubble levels”) comprising a sealed glass or plastic tube filled with a fluid (alcohol, water, chloroform, etc.). The tube not completely filled, but having a bubble of gas held therein. The tube being slightly curved so that the bubble will center itself, the gas being lighter than air, will move and/or rise towards the highest possible point when the tube is held “level.” Marking lines are generally applied to the tube adjacent to this area for giving a user a reference point for determining when the bubble is centered and thus the tube is “level.” This slight curvature providing a high point associated with the spirit level being level, so that when the spirit level is level, the bubble will visibly be located within these marking lines, thereby allowing a user to determine when a surface is level.

Levels and other leveling devices typically include at least two of these straight tube spirit vials, namely a horizontal vial and a vertical vial. To make the leveling device more accurate, each of these vials must be independently calibrated, thereby increasing the cost of the level. Having two separate vials also increases the size of the level. Other levels will also include one more diagonal vial.

A number of alternative spirit level constructions are shown in the prior art. For instance, U.S. Pat. No. 1,776,189 (Lewis) shows an inclinometer having a circular bubble tube in which a liquid flows to provide a direct optical reading of the angular position of a surface. U.S. Pat. No. 2,541,215 (Davis), like Lewis, shows a spirit level having a circular bubble tube. U.S. Pat. No. 2,645,030 (Mahone) shows yet another circular bubble tube inclinometer. U.S. Pat. Nos. 3,568,325 (Baltz) and 3,699,661 (Baltz) show liquid level devices having a circular bubble tube.

What is needed is a single vial combination horizontal and vertical level device. The present invention solves this need.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The present invention is a generally L-shaped bubble/spirit level vial, preferably for use in carpenter's levels, torpedo levels, string levels, and/or electronic levels. This vial having a vertical portion that is perpendicular to a horizontal portion. Both the vertical and horizontal portions fluidly interconnected so that the same, combined vial can be used either horizontally or vertically. Additionally, the vial could be used at an angle, thereby giving a 45-degree level vial opposite a 135-degree level vial.

The purpose of the foregoing Abstract is to enable the United States Patent and Trademark Office and the public generally, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a side view of the preferred embodiment of the present invention.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

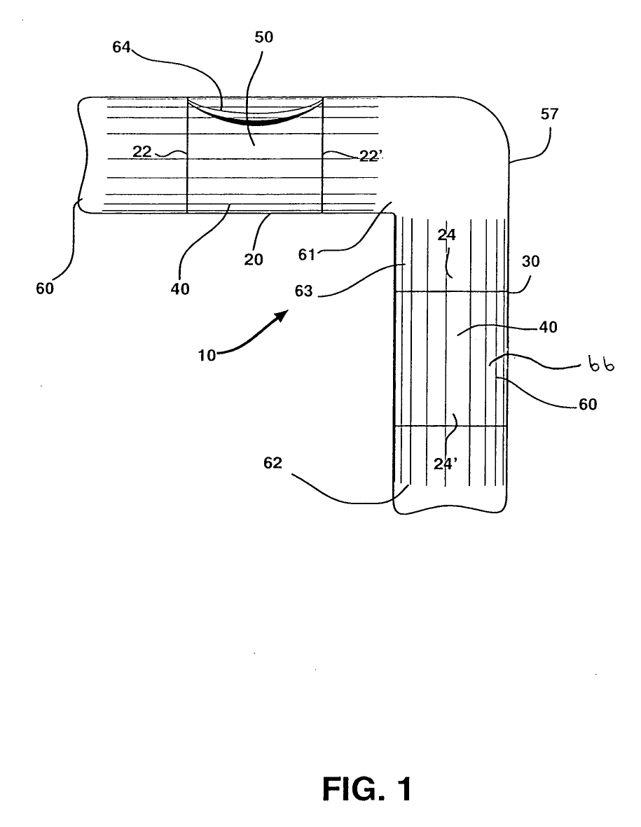

Referring to FIG. 1, the present invention is a generally L-shaped or V-shaped level vial 10. Other shapes are possible, including T-shaped, but less preferred. This vial 10 having a first arm portion 30, which is perpendicular to a second arm portion 20. Both the first arm (vial) portion 30 and the second arm (vial) portion 20 are fluidly interconnected so that the same, combined vial can be used either horizontally or vertically (the fluid/bubble within the vial is freely able to transition through both arm portions).

The first vial portion 20 preferably comprising a generally circular tubular structure, having a sealed first end 60 extending to a second end 61. The second vial portion 30 preferably comprising a generally circular tubular structure, having a sealed first end 62 extending to a second end 63. While circular tubular is the preferred structure, other structures are possible.

The vial 10, in one embodiment, comprising a tube precisely bent in a right (ninety degree) angle. Other manners of connecting the two tubes together include, but are not limited to: molding, adhesives, plastic welding, elbow connectors, connectors, stamping, extruding, etc.

The interior portions of these interconnected vials (or unitary vial bent into two perpendicular arms) filled with a fluid 40 (alcohol, water, chloroform, etc.). The interior portion(s) not completely filled, but having a bubble of gas 50 held therein. The tube(s) being slightly curved (curved region 64, 66) so that the bubble will center itself (the gas, being lighter than air, will move and/or rise towards the highest possible point when the tube is held “level”). Marking lines (22, 22′, 24, 24′) are generally applied to the tube adjacent to this area for giving a user a reference point for determining when the bubble is centered and thus the tube is “level.” This slight curvature providing a high point associated with the spirit level being level, so that when the spirit level is level, the bubble will visibly be located within these marking lines, thereby allowing a user to determine when a surface is level.

The benefits of such a vial include the fact that presuming that the vial is manufactured so that the horizontal (first arm) portion 20 (and/or the curved portion) is perfectly perpendicular to the vertical (second arm) portion 30, then only the vertical portion or the horizontal portion will need to be calibrated (because the second vial is at 90 degrees from the first vial; the second vial is itself calibrated when the first vial is calibrated).

As stated supra, the present invention can be formed through a number of processes, including but not limited to joining two separate tube arms together at an elbow, joining two separate tube arms together through use of a connector, such as an elbow connector 57, forming the device in such perpendicular structure, bending a single vial at a generally 90-degree angle to form a “first vial” portion and a “second vial” portion.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

1. A leveling device, said device comprising:
a first generally tubular vial portion defining an interior portion therein, said vial portion having a closed first end and an open second end;
a second generally tubular vial portion defining an interior portion therein, said vial portion having a closed first end and an open second end, said first vial second end connected to said second vial second end so that said vials are generally perpendicular to one another, said interior portions thereby fluidly interconnected to one another;
a liquid, said liquid generally filling said interconnected interior portions;
a bubble of gas within said interconnected interior portions;
said first vial further comprising a curved level region within said interior portion for receiving said bubble of gas when said first vial is level, said curved level region denoted to a user by a pair of opposing marks on said first vial; and
said second vial further comprising a curved level region within said interior portion for receiving said bubble of gas when said second vial is level, said curved level region denoted to a user by a pair of opposing marks on said second vial.

2. A leveling device, said device comprising:
a first generally tubular vial defining an interior portion therein, said vial having a closed first end and an open second end;
a second generally tubular vial defining an interior portion therein, said vial having a closed first end and an open second end;
a connector for connecting said first vial second end to said second vial second end so that said vials are generally perpendicular to one another, said interior portions thereby fluidly interconnected to one another;
a liquid, said liquid generally filling said interior portions;
a bubble of gas within said interior portions;
said first vial further comprising a curved level region within said interior portion for receiving said bubble of gas when said first vial is level, said curved level region denoted to a user by a pair of opposing marks on said first vial; and
said second vial further comprising a curved level region within said interior portion for receiving said bubble of gas when said second vial is level, said curved level region denoted to a user by a pair of opposing marks on said second vial.

3. A leveling device, said device comprising:
a first generally tubular vial portion defining an interior portion therein, said vial portion having a closed first end and an open second end, a curved level region within said first vial interior portion for receiving a bubble of gas when said first vial is level, said curved level region denoted to a user by a pair of opposing marks on said first vial; and
a second generally tubular vial portion defining an interior portion therein, said vial portion having a closed first end and an open second end, a curved level region within said second vial interior portion for receiving a bubble of gas when said second vial is level, curved level region denoted to a user by a pair of opposing marks on said second vial;
said first vial second end connected to said second vial second end so that said curved level regions are generally perpendicular to one another;
said interior portions thereby fluidly interconnected to one another;
a liquid, said liquid generally filling said interconnected interior portions; and
a bubble of gas within said interconnected interior portions.
